(19) United States
(12) Patent Application Publication
(10) Pub. No.: US 2002/0007246 A1
(43) Pub. Date: Jan. 17, 2002

(54) Method and apparatus for heading for intermediate destinations

(76) Inventors: Reinhold Baur, Neu-Ulm (DE); Jan Kettula, Ulm-Donau (DE); Peter Prestele, Vohringen (DE)

Correspondence Address: PERMAN & GREEN, 425 POST ROAD, FAIRFIELD, CT, 06430, US

(21) Appl. No.: 09/876,585

(22) Filed: Jun. 7, 2001

(30) Foreign Application Priority Data
Jun. 9, 2000 (DE) 10028662.3

(51) Int. Cl. G01C 21/36

(52) U.S. Cl. 701/209; 701/201; 701/211

(57) ABSTRACT

When heading for an intermediate destination during navigation e.g. of a motor vehicle along a preset travel route to a travel destination using a navigation device (11), a category of intermediate destination is imparted to the navigation device, and it is informed after what time the intermediate destination is to be reached. During navigation along the travel route the navigation device will then automatically select and head for an intermediate destination of the named category which can be reached at the given time.

### DESCRIPTION

The invention concerns a method for heading for intermediate destinations according to claim 1 as well as an apparatus for carrying out the method according to claim 5.

According to the state of the art, arrangements which after the input of a destination output a distance to this destination are known. These arrangements, which are also known as navigation systems or routefinders, are as a general rule provided with a GPS module for ascertaining the instantaneous geographical position, a data bank and a calculation assembly which, with the aid of the data delivered by the GPS module together with the data of the data bank, ascertains the distance to the destination. Depending on the design, the user can be provided with the ascertained route visually and/or acoustically.

These known systems are not just limited to routing to final destinations, but also allow a limited number of intermediate destinations to be inputted. If for example a user wants to drive from Frankfurt to Munich and at the same time wants to keep another appointment in Karlsruhe, apart from entry of the destination (Munich, Ottostrasse 4) he must also enter the location entry for his intermediate destination (Karlsruhe, Karlstrasse 8). This is of course tedious, but for individuals not possible any other way. However, there are many intermediate destinations which are of interest to the user, but their precise address is unimportant. If, for example, a user wants to have lunch in accordance with his demands on his journey from A to B, he is required first to find out about suitable restaurants and/or hotels and, after he has struck lucky, to inform the routefinder of the restaurant found with full address as an intermediate destination. Apart from the fact that this procedure is tedious, it also has the drawback that routing to the intermediate destination is unimportant to the user if he can no longer reach the restaurant selected by him in the time slot planned by him, owing to delays caused by congestion.

It is the object of the invention to provide a method and an apparatus to allow very flexible routing to the intermediate destinations which are of interest only by category, wherein the expenditure on input is to be reduced to a minimum.

A solution for a method for achieving the set object is provided in claim 1. On the other hand a solution for an apparatus for achieving the set object is to be found in claim 5. Advantageous embodiments of the invention are characterised in the dependent subsidiary claims.

In a method according to the invention for heading for an intermediate destination during navigation along a preset travel route to a travel destination using a navigation device, a category of intermediate destination is imparted to the navigation device, and it is informed after what time the intermediate destination is to be reached. During navigation along the travel route to the travel destination, the navigation device will then automatically select and head for an intermediate destination of the named category which can be reached at the given time.

After entering the category of intermediate destination and the time after which the intermediate destination is to be reached, the navigation device automatically monitors the environment during navigation along the preset travel route and scans the map for intermediate destinations of the named category. In the process the times which are needed by the preset travel route up to the intermediate destinations to reach the intermediate destinations are ascertained continuously. If it is established that the intermediate destinations will be reached too early, navigation is continued along the preset travel route, and hence the latter is not left. Only if intermediate destinations of the named category which can be reached just before expiry of the preset time are found, does navigation to such a destination determined by category take place. This can be alongside the preset travel route or on the preset travel route, if for example a motorway restaurant is concerned.

Categories of intermediate destinations are e.g. restaurants, hotels, petrol stations, museums, etc., but also restaurants or hotels of certain classes, and the like.

Notification to the navigation device regarding the category of intermediate destination and the entry of the time after which the intermediate destination is to be reached, can take place before commencement of or during navigation along the travel route. In this case according to an advantageous embodiment of the invention it is also possible to have only those intermediate destinations which lie in the direction towards the travel destination selected and headed for by the navigation device. In this way the travel distance is prevented from being extended too much.

It is also possible to have only those intermediate destinations which at the time of selection are below a given distance from the navigation device selected and headed for by the navigation device. This prevents e.g. the preset travel route from being left too early and too long a distance to the intermediate destination having to be covered.

An apparatus according to the invention for heading for an intermediate destination during navigation along a preset travel route to a travel destination using a navigation device contains a first input device for imparting the category of an intermediate destination to the navigation device, and a second input device for indicating to the navigation device after what time the intermediate destination is to be reached. The navigation device is in this case designed in such a way that during navigation along the travel route it automatically selects and heads for an intermediate destination of the named category which can be reached at the given time.

Since, during navigation along the preset travel route to the travel destination, the navigation device constantly scans not only the environment for intermediate destinations predetermined according to category, but also takes into consideration the traffic situation on the preset travel route as well as on the possible roads to the intermediate destinations, allowance can be made for traffic jams, diversions, etc. during navigation and in particular when deciding which of the intermediate destinations of the named category is to be headed for. This ensures that even in unforeseen circumstances a user always arrives at the intermediate destination on time.

### BRIEF DESCRIPTION OF FIGURES

They show:

FIG. 1 a sequence of input of destination and intermediate destination according to the state of the art;

FIG. 2 a sequence of input of destination and intermediate destination according to the invention;

FIG. 3 further details of intermediate destination input according to FIG. 2 and

FIG. 4 a sequence for the input of a set dialogue for intermediate destinations.

### WAYS OF EXECUTING THE INVENTION

The invention will now be described in more detail with the aid of the figures.

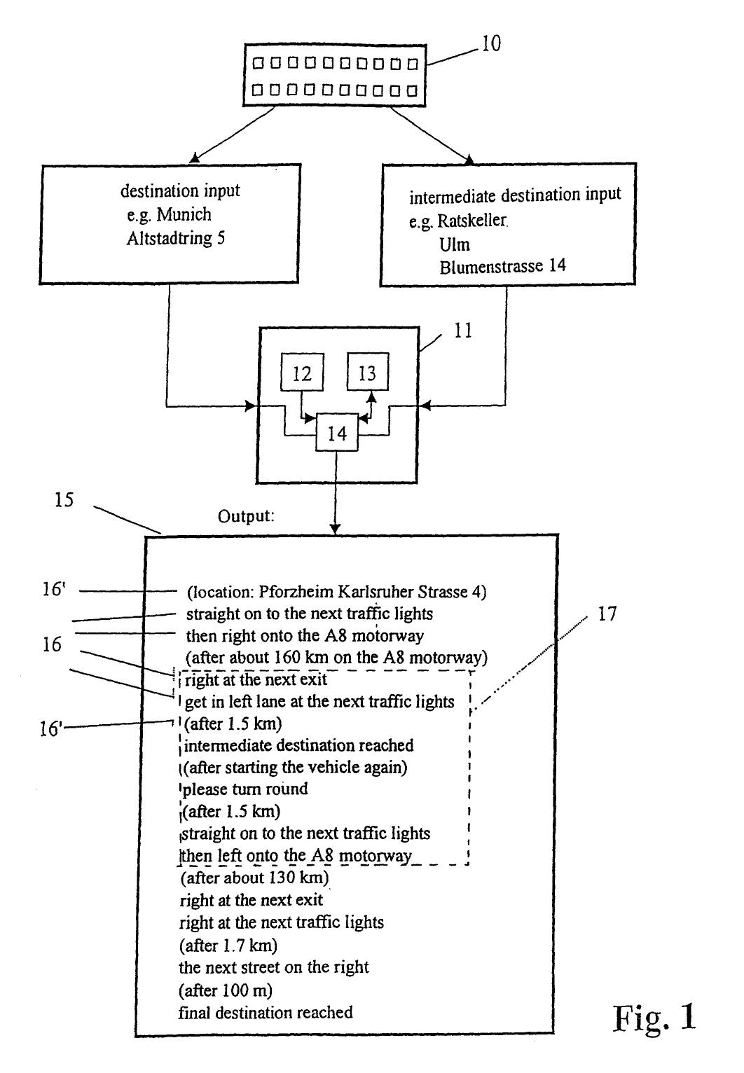

In FIG. 1 is shown the sequence of data input and output according to the state of the art for a journey from Pforzheim, Karlsruher Strasse 4 to Munich, Altstadtring 3, in which the intermediate destination is to be the restaurant Ratskeller in Blumenstrasse 14 in Ulm.

If a user who wants to undertake such a journey wants to be guided by a routefinder, he must first enter the destination input (Munich, Altstadtring 5) manually via a keyboard 10, or convey the destination input to the assembly 11 for example by transmission of a data record containing the destination input. If the journey is to be interrupted for example in Ulm for lunch, the user is required to convey this intermediate destination via the keyboard 10, this being before or during the journey to the destination. This requires not only knowledge of the intermediate destination (e.g. name of the restaurant or address of the restaurant), but also extra input work. The latter is not uncritical if for example the entries for the intermediate destination are made by the driver of the vehicle during the journey. Even if the input problems during the journey can be reduced by a voice input, there still remains the problem of knowing of the address of the intermediate destination.

When the respective entries for the destination (Munich, Altstadtring 5) and the intermediate destination (Ulm, Blumenstrasse 14) have been made and transferred to the assembly 11, the distance is ascertained from these entries. For this purpose the assembly 11 is provided with a GPS module 12, a data bank 13 and calculation assembly 14. Only for the sake of completeness it should be pointed out that the data bank 13 does not necessarily have to be integrated in the assembly 11, but can be installed either completely or at least partially at a distance from the assembly 11 and exchange data with the latter wirelessly, for example.

As the instantaneous location of the assembly 11 is known to the latter on account of the data supplied by the GPS module 12, on the basis of the information filed in the data bank 13 the distance can be ascertained from these data together with the data for the destination and intermediate destination input in the calculation assembly 14. This then leads to an output which in FIG. 1 is given the reference number 15. To prevent possible misunderstandings in this connection, it should be pointed out that the output of the distance does not, as shown in FIG. 1, have to appear as continuous text on a display, but the respective row information 16 can also be made available to the user as voice output, depending on the distance already covered.

It can be seen clearly from the output 15 that some of the row information 16 is encased in a, continuous dotted line 17. This row information 16 is such as is necessary to reach the intermediate destination on the road from Pforzheim to Munich. Only for the sake of completeness it should be mentioned that the row information 16′ enclosed in brackets in the representation of the output 15 is not outputted, but merely serves for a better understanding of the invention.

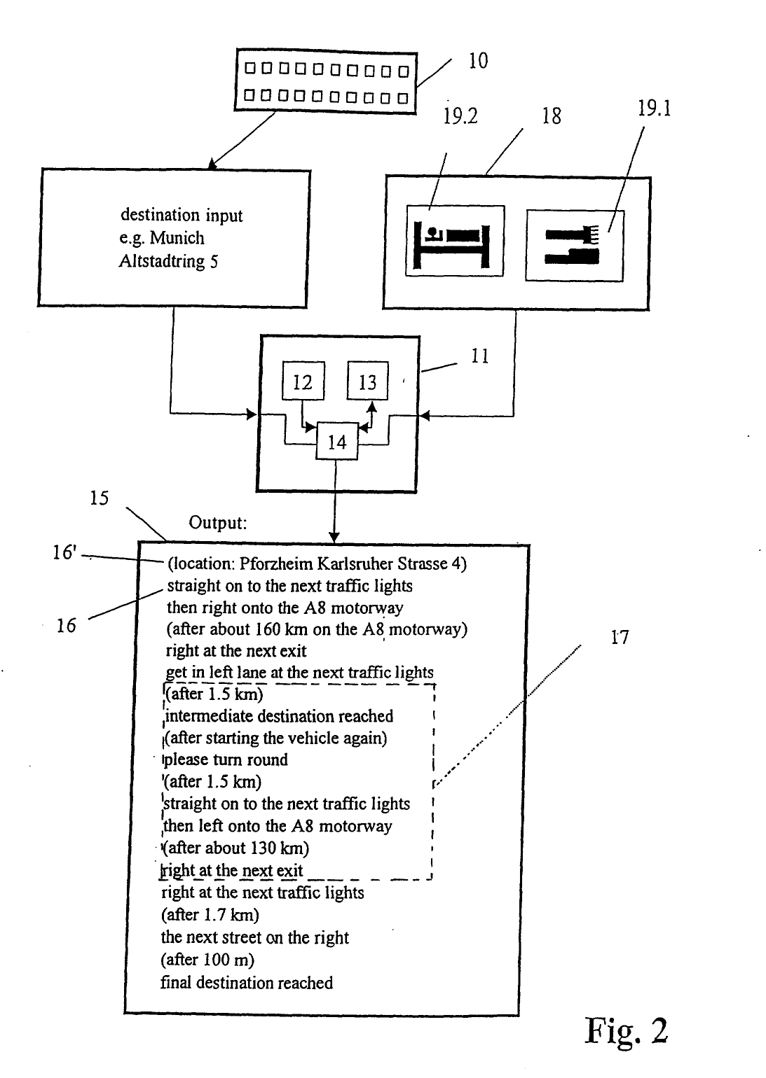

In FIG. 2 is shown a sequence according to the invention which essentially corresponds to the sequence according to FIG. 1, so that reference numbers used in FIG. 1 also keep their values in FIG. 1.

Unlike FIG. 1, in FIG. 2 there is a function unit 18 which comprises two physical keys 19. One key 19.1 is provided with a restaurant symbol and the other key 19.2 with a hotel symbol. If physical keys 19 are to be avoided, in another embodiment not shown further the function unit 18 can be provided with virtual keys by providing, for example on a display, switching areas which are capable of operation with a cursor and bear the restaurant and hotel symbols. If keys of any design are to be avoided, the function unit 18 can be provided with a microphone with connected voice detection unit reacting for example to the words restaurant and hotel.

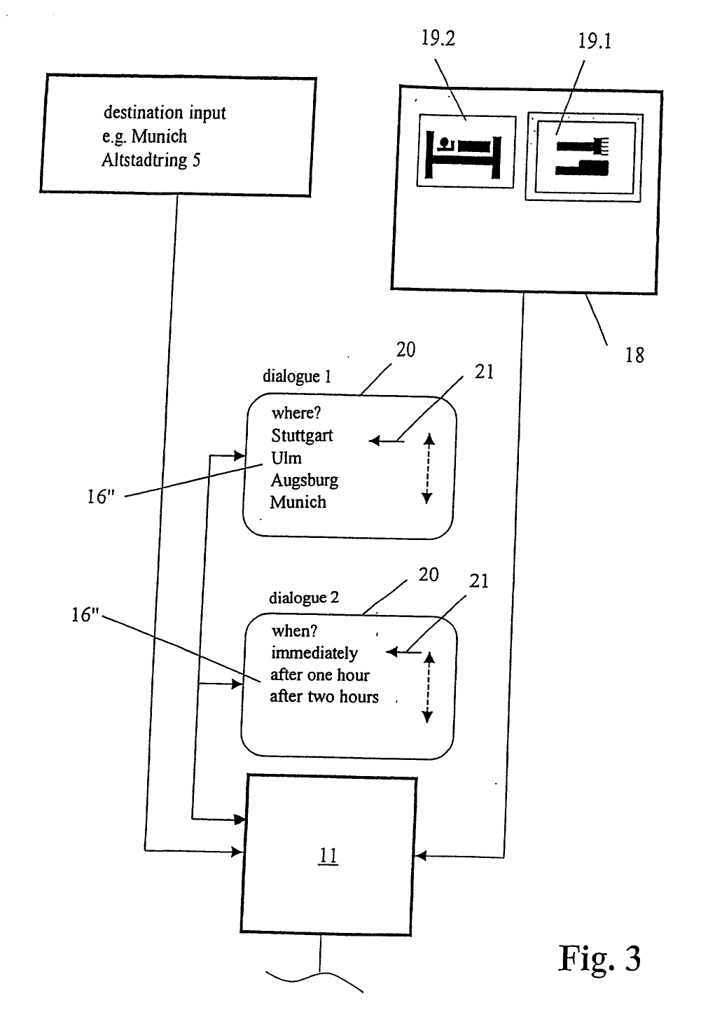

If, as shown in FIG. 3 by the grey border, the key 19.2 with the restaurant symbol is operated or, in the case of the function unit not shown further and comprising a microphone with connected voice detection, the word “restaurant” is imparted to the function unit 18, a dialogue is opened.

Such a dialogue is shown in FIG. 3 and there referred to as dialogue 1. This dialogue 1 has a row of row information 16″ and includes a list of place names which lie along the road between the starting point (Pforzheim) and the destination (Munich). By means of the cursor 21 which is also present in dialogue 1, the location in which the user for example plans to have lunch in a restaurant can then be selected. If in dialogue 1 none of the places offered has been selected or if the user has not entered any destination (Munich), the assembly 11 can be organised in such a way that then by means of the GPS module 12 the instantaneous position is ascertained and then with the aid of this position a selection of places and/or restaurants which lie within a radius of for example 15 km are provided in dialogue 1.

If the user in dialogue 1 for example confirms the row information 16″(Ulm), on his journey from Pforzheim to Munich he is then guided to a restaurant in Ulm, without special knowledge of the situation of the restaurant being required.

In FIG. 3, apart from dialogue 1, another dialogue 2 is shown. This dialogue 2 can, depending on the design, either replace dialogue 1, or be offered to the user as an alternative to dialogue 1 which can be called up. This dialogue 2 differs from dialogue 1 in that it is not location details, but time slots that are made available to the user there as row information 16″. If the user on his journey from Pforzheim to Munich has for example operated the key 19.1 at a time t1 and selected and confirmed the row information 16″(after one hour) in the box 20 with the cursor 21, a restaurant along the road is sought for the time t2=t1+60 min, and the user is guided to this restaurant by the fact that for example at a time t2−10 min by means of the GPS module 12 the position applicable at time t2−10 min is ascertained and, starting from this position, a restaurant is sought and the user is guided to this restaurant.

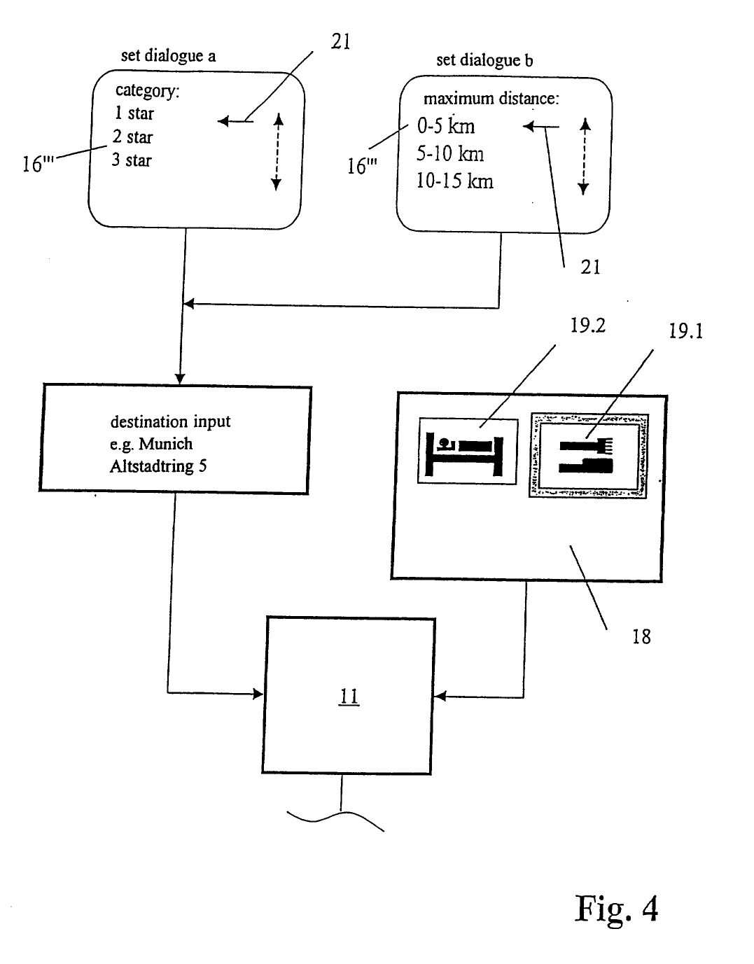

Since some restaurant or some hotel is sought by means of the guide system described above and triggered by the function unit 18, and this restaurant or hotel possibly does not match the user's ideas, a set dialogue is provided. In FIG. 4 are shown two set dialogues a, b which refer to the key 19.1 (shown by the border). If the user has called up set dialogue a, he can select the category of restaurant with the cursor 21 there, while in set dialogue b he can set the maximum distance of the restaurant from the road. Since the set dialogues not only must be confined to the two set dialogues a and b shown in FIG. 4 and the settings in the set dialogues can be comprehensive, it is provided that the set dialogues a, b can be called up only if, when used in a motor vehicle, the latter is stationary. If the user has selected “2 star” as the row information 16″ in set dialogue a and “0-5 km” as the row information 16′″ in set dialogue b, until a change of these entries in the set dialogues a and b, on operation of the key 19.1 the user will always be guided by the corresponding outputs to the restaurants which have a “2 star” category and are not more than 5 km away from the road. For the journey from Pforzheim to Munich this means that, if the user according to FIG. 3 by operation of the key 19.2 confirms a restaurant stop in Ulm in dialogue 1, he is then guided to the restaurant Ratskeller in Blumenstrasse 14 in Ulm, if this restaurant fulfils the criteria according to set dialogues a and b. If not, perhaps because in relation to the instantaneous position the distance according to set dialogue b can no longer be kept to or because the restaurant Ratskeller is a 3-star one, the user is then guided to another restaurant in Ulm fulfilling the criteria of set dialogues a and b.

Only for the sake of completeness it should be pointed out that the function unit 18 does not necessarily have to be limited to routing to restaurants and hotels. Instead, in another embodiment routing to petrol stations or sights can be organised in this way.

Furthermore it can also be provided that a user who is for example interested in certain museums has these museums indicated to him if his journey takes him past such a museum and the user has once, perhaps before starting the journey in a mask similar to the set dialogues, entered the type of museums as well as their maximum distance from the road. If the user then later during the journey confirms the indication of a museum found, he is automatically guided to the museum.

What is claimed is:

1. Method for heading for an intermediate destination during navigation along a preset travel route to a travel destination using a navigation device, in which a category of intermediate destination is imparted to the navigation device, and it is informed after what time the intermediate destination is to be reached, and in which during navigation along the travel route the navigation device automatically selects and heads for an intermediate destination of the named category which can be reached at the given time.

2. Method according to claim 1, characterised in that notification of the category of intermediate destination and the entry of the time after which the intermediate destination is to be reached, take place before commencement of or during navigation along the travel route.

3. Method according to claim 1, characterised in that only those intermediate destinations which lie in the direction towards the travel destination are selected and headed for by the navigation device.

4. Method according to claim 1, characterised in that the navigation device selects and heads for only those intermediate destinations which at the time of selection are below a given distance from the navigation device.

5. Apparatus for heading for an intermediate destination during navigation along a preset travel route to a travel destination using a navigation device (11) with a first input device (18, 19.1, 19.2) for imparting the category of an intermediate destination to the navigation device (11), and with a second input device (20, 21) for indicating to the navigation device (11) after what time the intermediate destination is to be reached, wherein the navigation device (11) is designed in such a way that during navigation along the travel route it automatically selects and heads for an intermediate destination of the named category which can be reached at the given time.

6. Apparatus according to claim 5, characterised by an input device for the input of distances to the navigation device up to which the intermediate destinations may lie on selection thereof.
